(19) United States
(12) Patent Application Publication
(10) Pub. No.: US 2024/0313317 A1
(43) Pub. Date: Sep. 19, 2024

(54) Compressive Stressing Device for a Frame Arrangement for Clamping a Battery Cell Assembly, Frame Arrangement and Battery

(71) Applicant: Bayerische Motoren Werke Aktiengesellschaft, Muenchen (DE)

(72) Inventors: Maximilian ALTMANN, Muenchen (DE); Philip KOTTER, Muenchen (DE)

(21) Appl. No.: 18/576,423

(22) PCT Filed: Aug. 23, 2022
(86) PCT No.: PCT/EP2022/073371

§ 371 Date: Jan. 4, 2024

(30) Foreign Application Priority Data
Sep. 22, 2021 (DE) 10 2021 124 467.6

(51) Int. Cl. H01M 50/242; H01M 50/249; H01M 50/264

(52) U.S. Cl. CPC H01M 50/242; H01M 50/249; H01M 50/264

(57) ABSTRACT

Please substitute the new Abstract submitted herewith for the original Abstract: A compressive stressing device for a frame arrangement and a battery having the frame arrangement. The compressive stressing device has a fastening part, a bracing part and a bracing joint mechanism. The compressive stressing device can be fastened to a tensile stressing device of the frame arrangement by way of the fastening part. The bracing part is designed to come to lie against the battery cell assembly. The fastening part and the bracing part are connected to one another by way of the bracing joint mechanism, the bracing joint mechanism being designed such that, when the bracing part is subjected to a bracing force acting in the direction of the fastening part, the bracing part is moved in a bracing direction towards the fastening part by the bracing joint mechanism yielding in a defined manner.

### BACKGROUND AND SUMMARY

The present disclosure relates to a pressure clamping device for a frame arrangement which is designed to clamp a battery cell pack. Furthermore, the disclosure relates to a frame arrangement for clamping a battery cell pack, wherein the frame arrangement has such a pressure clamping device. The disclosure further relates to a battery which has the frame arrangement and a battery cell pack, which has a large number of battery cells arranged beside one another and clamps the battery cell pack in the clamping region.

Motor vehicles that can be driven or moved at least partly electrically, for example hybrid motor vehicles, electric motor vehicles, etc., have a battery, in particular a secondary battery, for storing and providing electrical energy for driving the corresponding motor vehicle via an electromechanical energy converter. The battery is typically formed from a large number of battery cells which, for example, are designed as respective pouch cells or prismatic cells. The respective battery cell is repeatedly charged (charging state SoC becomes higher) and discharged (charging state SoC becomes lower) during operation of the motor vehicle, wherein the respective battery cell in the discharged state (SoC equal to or close to 0) and in the charged state (SoC greater than 0) has different external dimensions, which means different dimensional extents. In other words, because of an electrical charge, the battery cell swells to a swollen dimension (SoC>0), starting from a basic dimension at SoC≈0. In addition, the battery cell expands irreversibly with increasing age, which means that the basic dimension rises with the increasing age of the battery cell. Furthermore, a defective battery cell can swell or become swollen to the swollen dimension.

If a conventional rigid frame is used to hold the battery cells, frame elements, in particular joints of the frame, are highly loaded, since the battery cells expand to the swollen dimension. Furthermore, it is possible that during manufacturing/production of the conventional battery, the battery cells are clamped too highly in an undesired manner if at least one or more of the battery cells have a greater thickness as compared with a target thickness because of manufacturing tolerances. Possibly, the excessively high clamping is associated with damage to the electrodes and/or a separator and, consequently, a premature end of the service life. Furthermore, it is currently possible only with considerable effort to detect optically whether a conventional battery or a conventionally battery module, which means one or more of the conventional battery cells, is or are damaged or worn. For a service technician, for example within the context of vehicle maintenance and/or repair, the rigid frame presents as unchanged, at least on the outer side, regardless of whether battery cells have the basic dimension or the swollen dimension. In addition, the conventional, highly strongly rigidly designed frame is to be viewed as a non-deformable element in the event of an accident of the motor vehicle equipped with the battery. As a result, an overall space that can be used for the installation of battery cells is limited, since spaces and/or elements (“deformation zones”) have to be provided in the motor vehicle for safety in the event of an accident, deforming in the event of an impact—as far as possible in a controlled manner—in order to efficiently dissipate kinetic energy present in the crash. The deformation zones must be kept free of non-deformable elements (so-called block formers). Furthermore, deformation of the battery or of the battery module must be avoided since otherwise thermal runaway could occur in the event of a crash, as a result of a mechanical overload.

Because of the dimension change occurring during the operation of the respective battery cell, constructive measures have to be taken to absorb or compensate for the physical dimension change in the installed position of the battery cells. The physical dimension change manifests itself in up to a 10% difference in volume for each battery cell between the charged and the discharged state. Thus, DE 10 2018 216 835 A1 and DE 10 2019 201 126 A1 each disclose a battery module having a clamping device which has two supporting elements spaced apart from each other via a wavy spring. Conventional battery cells are then clamped in between one of the two supporting elements and a counter bearing. However, these conventional battery modules are particularly complicated as regards their production, since the clamping device is formed in many parts, and the parts of the clamping device are provided separately from one another in order then to be arranged on one another.

It is an object of the present disclosure to devise a possible manner of particularly advantageously using and arranging battery cells which change with regard to their physical extent during operation.

According to the disclosure, a pressure clamping device is proposed, wherein the pressure clamping device is provided for a frame arrangement which is designed to clamp a battery cell pack. For this purpose, the pressure clamping device has a fastening part, via which the pressure clamping device can be fastened as intended—directly or indirectly—to a tensioning device of the frame arrangement. For example, the fastening part of the pressure clamping device can be fastened to a tensioning element of the tensioning device. To this extent, provision can be made for the tensioning device to have the tensioning element or a plurality of tensioning elements. In order to connect or to fix the fastening part as intended to the tensioning device, the fastening part has a fastening element, for example. To this end, the fastening part has, for example, a welding surface and/or at least another fastening element acting in a force-fitting, form-fitting and/or integral manner. The tensioning device, in particular its tensioning element or its tensioning elements, has a fastening element corresponding to the fastening element of the fastening part.

The battery cell pack is provided in particular for a motor vehicle that can be driven or moved at least partly electrically. The motor vehicle is, for example, a passenger car and/or a truck, a bus, a motorcycle, etc. Furthermore, a use of the battery cell pack in other vehicle types (watercraft, aircraft, rail vehicle, etc.) is envisioned. In the intended installed position of the battery cell pack, the battery has the battery cell pack. The battery cell pack has a large number of battery cells arranged beside one another or above one another, in particular secondary battery cells. The respective battery cell or secondary battery cell is, for example, designed as a solid-state battery cell. Accordingly, a respective battery cell therefore has a solid body electrolyte in this case. In particular, the respective battery cell is additionally free of any liquid. Battery cells implemented in this manner are designated ASSB cells (ASSB: All-Solid-State Battery). Solid-state battery cells have advantages with regard to a particularly high specific energy density and with regard to improved operational safety.

The pressure clamping device additionally has a clamping part which is designed to lie as intended-directly or indirectly-against the battery cell pack. In particular, the clamping part has a clamping surface which corresponds to a contact surface of the battery cell pack, so that the clamping part comes to lie against the battery cell pack by the clamping surface of the clamping part and the contact surface of the battery cell pack touching each other directly or indirectly. The contact surface of the battery cell pack can be at least part of an outer surface of a “last” battery cell, no further battery cell being arranged between this last battery cell and the clamping surface of the clamping part.

Furthermore, the pressure clamping device has a clamping joint mechanism, by which the fastening part and the clamping part are connected to each other-directly or indirectly. For example, the fastening part and the clamping part are fastened to one another in a force-fitting, form-fitting and/or integral manner via the clamping joint mechanism. In other words: the clamping joint mechanism and the fastening part or the clamping joint mechanism and the clamping part do not simply lie against one another without any force-fitting, form-fitting and/or integral connection. In other words, at least at appropriate connecting elements, a relative movement is blocked, in particular in relation to all three spatial directions, between the clamping joint mechanism and the fastening part and also between the clamping joint mechanism and the clamping part. This is because the fastening part and the clamping part are connected to each other, i.e. fixed to one another, via the clamping joint mechanism.

The clamping joint mechanism is in any case designed in such a manner that if a clamping force is applied to the clamping part in the direction acting toward the fastening part, the clamping part is moved in a clamping direction toward the fastening part, by the clamping joint mechanism yielding in a defined manner. Since the pressure clamping device has the clamping joint mechanism, the pressure clamping device is a compliant system.

If the clamping joint mechanism is connected to the tensioning device as intended, by which the frame arrangement is formed, the clamping joint mechanism is at least compressible by at least one battery cell of the battery cell pack which is clamped via the frame arrangement swelling to a swollen dimension. Here, the swollen dimension of the corresponding battery cell is greater than a basic dimension of the corresponding battery cell. The swelling of the battery cell from its basic dimension to the swollen dimension depends, for example, on a current charging state (SoC: state of charge). Thus, in a discharged state (SoC=0), the battery cell has the basic dimension, whereas in the charged state (SoC>0), the battery cell has the swollen dimension. If the battery cell has the swollen dimension, it is larger in at least one spatial direction than when the battery cell has the basic dimension. For example, the corresponding battery cell is then thicker. Expressed simply, the battery cell is wider and/or longer and/or higher when it has the swollen dimension than when the battery cell has the basic dimension.

As the corresponding battery cell swells, its change in size within the frame arrangement is compensated or absorbed or offset by the pressure clamping device, in particular by the clamping joint mechanism, in that as a result of the swelling of the corresponding battery cell, the clamping force acting in the direction toward the fastening part is applied to the clamping part, so the clamping part is moved in the clamping direction toward the fastening part, the clamping joint mechanism yielding in a defined manner. In particular, provision is made for the fastening part and the tensioning device-irrespective of whether the clamping joint mechanism yields or has yielded-remaining unmoved relative to each other, so that the swelling of the battery cell is not reflected in a change in size of the frame device on the outside of the frame arrangement. The geometry and external dimensions of the frame arrangement therefore remain constant on the outside, irrespective of whether the battery cell has the basic dimension or the swollen dimension. External dimensions of the frame arrangement, in particular external dimensions of the pressure clamping device and/or the tensioning device, thus do not change during cycling (repeated electrical charging and discharging during intended operation) of the corresponding battery cell.

Furthermore, the pressure clamping device efficiently prevents the battery cell being clamped too highly in an undesired manner, for example as a result of manufacturing tolerances of the battery cell. This is because a possibly larger thickness as compared with a target thickness of the battery cell—in particular during the production of a battery having the frame arrangement—is compensated by the clamping joint mechanism. Furthermore, it is particularly simple to detect optically whether the battery, in particular one or more of the battery cells, is damaged or worn, by measuring an angle and/or a spacing between elements of the pressure clamping device, in particular between elements of the clamping joint mechanism. In particular, when the battery or the battery module is close to the end of its service life, if the clamping joint mechanism has yielded highly or to a great extent, it is particularly easy to detect that elements of the clamping joint mechanism touch each other directly, which means when the clamping joint mechanism has yielded to a blocking dimension.

In addition, a space between the fastening part and the clamping part into which the clamping joint mechanism is inserted can be used as a deformation zone in the event of an accident. As a result, it is no longer necessary to provide a space between the frame arrangement, in particular between the pressure clamping device, and spaces or elements which deform in the event of an impact since, during the impact, as a result of the clamping joint mechanism yielding, the kinetic energy that is present during the impact is dissipated efficiently. In this manner it is, for example, possible to use further or additional battery cells, which advantageously leads to an increased range of a motor vehicle equipped with the battery described herein.

In order to ensure a particularly long service life and particularly reliable operation of the battery cell pack or its battery cells, provision is made in particular for the clamping joint mechanism to be configured in such a manner, which means designed and arranged in such a manner, that an initial pressure acts on the respective battery cell even if the corresponding battery cell has not swollen. The clamping joint mechanism is therefore designed and arranged in such a manner that the initial pressure acts on the respective battery cell even if the battery cell has the basic dimension.

In a further refinement of the pressure clamping device, provision is made for the clamping joint mechanism to have a deformation component of the fastening part, so that the clamping joint mechanism yields in a defined manner by the deformation component deforming, in particular being bent. To this extent, the deformation component of the fastening part can be a bending component of the fastening part. The fastening part, in particular its deformation component or bending component, is thus viewed herein as a bending element or bending joint of the clamping joint mechanism. Depending on the material thickness and/or material type and/or geometric configuration of the fastening part or its deformation component, particularly high swelling and, as a result, particularly high clamping forces, can thus be compensated.

According to a development of the pressure clamping device, provision is made for the clamping joint mechanism to comprise a first joint or hinge device, wherein the joint device or hinge device has a first band element and a second band element. Furthermore, the joint or hinge device has a swivel joint or hinge on the fastening-part side, via which the fastening part and the first band element are connected to each other—directly or indirectly—in an articulated manner. Furthermore, the first joint device has a central swivel joint or a central hinge, via which the first band element and the second band element are connected to each other in an articulated manner. Furthermore, the first hinge device or the first joint device has a swivel joint on the clamping-part side or a hinge on the clamping-part side, via which the second band element and the clamping part are connected to each other in an articulated manner. To this extent, the fastening part and the clamping part are thus connected to one another via the swivel joint on the fastening-part side, via the first band element, via the central swivel joint, via the second band element, and via the swivel joint on the clamping-part side. As the clamping joint mechanism yields, the band elements yield in relation to one another in an articulated manner, in relation to the fastening part and in relation to the clamping part. Here, the swivel joints are, for example, deflected or rotated from a rest position into a deflected position. In order to predefine a respective direction of rotation of the respective swivel joint or hinge, provision is in particular made for the clamping joint mechanism to be produced or provided, wherein an angle that differs from 180 degrees is set between the band elements by the central swivel joint. Thus, a respective direction of rotation of the swivel joints or hinges as the clamping joint mechanism yields is or can be predefined.

Since the clamping joint mechanism having the joints or hinges is used between the fastening part and the clamping part, a kinematic relationship between the fastening part and the clamping part is produced which is configured in such a manner that a constant level of force prevails between the corresponding battery cell and the pressure clamping device. This constant force level is independent of deflection or yielding of the clamping joint mechanism. In other words, the battery cells of the battery cell pack have the initial pressure applied in a constant manner. At the same time, particularly high yielding is ensured by the kinematics, which means by the clamping joint mechanism.

In a development of the pressure clamping device, the pressure clamping device, in particular its clamping joint mechanism, can have more than one joint device. The joint devices can be spaced apart from one another and move equally or differently in the direction toward the fastening part during the movement of the clamping part. The respective central swivel joints of two joint devices or hinge devices can move in the same direction during the yielding of the clamping joint mechanism. The central swivel joints or hinges of the two (the same) joint devices can alternatively move toward each other during the yielding of the clamping device. Therefore, if the pressure clamping device has a plurality of joint devices or a plurality of hinge devices, these can be combined as desired serially, in parallel and/or sequentially, which means coupled to one another via corresponding swivel joints, in order to achieve the desired mechanical overall properties of the kinematic relationship between the fastening part and the clamping part. This means that the desired mechanical overall properties between the fastening part and the clamping part are produced in particular during production or by production of the pressure clamping device. The serial, parallel and/or sequential combination and a selection of wall thicknesses of the band elements and/or the swivel joints or hinges constitute important configuration parameters of the clamping joint mechanism.

In this connection, according to a development of the pressure clamping device, provision is made for the clamping joint mechanism further to have at least a second joint device, a third band element, and a fourth band element. In addition, the clamping joint mechanism then comprises a coupling swivel joint or a coupling hinge, via which the third band element and the fourth band element are connected to one another in an articulated manner. The third band element and the central swivel joint of the first joint device are connected to each other in an articulated manner, and the fourth band element and the central swivel joint of the second joint device are likewise connected to one another in an articulated manner. In this configuration, provision is therefore made for the respective central swivel joint of the two joint devices, which together form a joint device pair to be a respective triple swivel joint. By way of such a triple swivel joint, which means by way of the respective central swivel joint of the joint devices of the joint device pair, the respective first band element, the respective second band element, and the third band element or the fourth band element are rotatable or pivotable relative to one another, in particular about a common axis of rotation.

In general, the joints of the clamping joint mechanism have a resistance to articulated movement of the corresponding joint device. Thus, by way of the serial, parallel and/or sequential combination of the joint devices, a resistance to yielding of the clamping joint mechanism can be set or predefined. If then, the third band element and the fourth band element and the coupling swivel joint are possibly used between the joint devices of the joint device pair, the resistance to the yielding of the clamping joint mechanism can have a further resistance stage added without having to tolerate a greater overall height of the clamping joint mechanism. Furthermore, by way of the coupling swivel joint, the third band element and the fourth band element between the two joint devices, it is ensured that these deform or rotate in a defined manner, the central swivel joints of the two joint devices moving toward each other as the clamping joint mechanism yields.

In a further refinement of the pressure clamping device, the respective swivel joint or hinge is designed as a foil or film joint or foil or film hinge. The pressure clamping device is in this manner designed to be producible particularly simply or with little outlay, since at least the (respective) joint device, and possibly the third band element, and the fourth band element, and the coupling swivel joint, can be formed in one piece with one another. For example, the aforementioned elements can be produced in one piece with one another by way of extruding, by way of casting, by way of a generative manufacturing method (3D printing), etc.

According to a further refinement of the pressure clamping device, the fastening part, the clamping part, and the clamping joint mechanism are formed in one piece with one another. This means that the fastening part, the clamping part, and the clamping joint mechanism are, for example, formed by way of single common extruding, casting, etc. As a result of this one-piece, in particular simultaneous, formation of the fastening part, the clamping part and the clamping joint mechanism, carried out in a single, common operation, the pressure clamping device is produced in this one operation. This does not rule out the pressure clamping device having a plurality of in particular different materials, since one or more of the elements can be co-extruded with one another to produce the pressure clamping device. As an alternative to this, it is conceivable that one or more of the elements of the pressure clamping device is/are provided separately from the remaining elements of the pressure clamping device, so that to produce the pressure clamping device, the elements provided separately from one another and the remaining elements are fixed to one another in a force-fitting, form-fitting, and/or integral manner after the appropriate provision-therefore in a further operation. Since the pressure clamping device is formed in one piece, it is particularly stable and, as a result, has an advantageously particularly long service life.

If the pressure clamping device has both the fastening part with the deformation component and also at least one of the joint devices, stated before, in a development of the pressure clamping device, provision is made for a resistance to articulated movement of the joint device(s) to be designed in such a manner that the articulated movement of the joint device(s) takes place at a first clamping force. By contrast, a resistance to the deformation of the deformation component, in particular to the bending of the bending component, of the fastening part, is designed in such a manner that the deformation/bending takes place at a second clamping force. Here, provision is made either for the first clamping force to be higher than the second clamping force or for the second clamping force to be higher than the first clamping force. In this manner, in particular during the production of the pressure clamping device, a yielding sequence or deformation, and/or bending sequence of the pressure clamping device, can be predefined. To this end, a material, a material thickness and/or a shape of the joint device or joint devices and of the fastening part, in particular their deformation or bending component, is selected appropriately. The result of this selection is then either that during the yielding of the clamping joint mechanism, on account of the second clamping force, firstly the deformation component of the fastening part deforms, which means, for example, the bending component of the fastening part is bent, and only when the second clamping force occurs, are the swivel joints or hinges of the joint device(s) rotated. In the other case, during the yielding of the clamping joint mechanism, firstly, the joints of the joint device(s) are rotated on account of the second (lower) clamping force, and only when the first (higher) clamping force occurs, is the deformation component of the fastening part deformed. It is thus advantageously possible to predefine which of the elements of the pressure clamping device deforms first and/or more highly, as a result of which the pressure clamping device can be used particularly versatilely and/or flexibly, which means for a large number of purposes.

According to a development, the pressure clamping device, in particular the clamping device, is formed in such a manner that the yielding of the clamping joint mechanism is wholly or partly nondestructively reversibly elastic. In particular, provision is made for the yielding of the clamping joint mechanism, which means, for example, the deformation or bending of the deformation or bending component of the fastening part, and/or the rotation of the joints of the joint device(s), to be completely nondestructively reversibly elastic, at least in the region of the clamping force that depends on a charging cycle of the battery cells. This means that the pressure clamping device is designed to be self-resetting, at least in the yielding or deformation range, which is caused by the swelling and shrinking of the corresponding battery cell between its base dimension and its swollen dimension because of the cycling. Alternatively, or additionally, provision can be made for the yielding of the clamping joint mechanism to be at least partly plastic. In particular, provision is made in this connection for the yielding of the clamping joint mechanism to be plastic in the region of a clamping force, which is produced or applied to the clamping part on account of swelling of the corresponding battery cell that depends on service life.

To predefine whether and/or in what range the clamping joint mechanism is nondestructively reversibly or plastically deformable or flexible, an appropriate material selection is made in particular during the production of the pressure clamping device, in particular of the clamping joint mechanism. For example, with a metal, for example aluminum, a rather more plastic deformation behavior of the clamping joint mechanism can be constituted. If another metal is chosen and/or the corresponding metal is treated mechanically, thermally and/or mechanically, for example surface-treated, both elastic yielding and also plastic yielding of the clamping joint mechanism can be implemented, the elastic yield behavior and the plastic yield behavior merging into one another, for example. Furthermore, it is conceivable to form the clamping joint mechanism from a plastic, for example an elastomer, as a result of which account is taken to a particular extent of the idea of a particularly high elastic yield region of the clamping joint mechanism. Since, because of the plastic and/or elastic deformability or flexibility of the clamping joint mechanism, the clamping part follows the swelling and shrinking external dimensions of the battery cells, particularly firm seating, for example particularly reliable clamping, of the battery cell pack in the frame arrangement is ensured. Thus, a particularly beneficial NVH quality (NVH: Noise, Vibrations, Harshness) is achieved.

The disclosure also relates to a frame arrangement for clamping a battery cell pack. Features, advantages, and advantageous refinements of the pressure clamping device according to the disclosure are to be viewed as features, advantages and advantageous refinements of the frame arrangement according to the disclosure, and vice versa. The frame arrangement comprises a pressure clamping device designed according to the above description and a counter bearing, wherein the counter bearing and the pressure clamping device are spaced apart from each other along a longitudinal direction of the frame arrangement. Furthermore, the frame arrangement has a tensioning device, which has a first tensioning element and a second tensioning element. The tensioning elements are spaced apart from one another along a transverse direction of the frame arrangement. In addition, the pressure clamping device and the counter bearing are fastened to each other by way of tensioning elements, so that a clamping region, in which the battery cell pack can be inserted and clamped, is formed along the longitudinal direction and along the transverse direction between the pressure clamping device and the counter bearing.

Moreover, the disclosure relates to a battery which has a frame arrangement designed according to the above description and a battery cell pack. Features, advantages, and advantageous refinements of the pressure clamping device according to the disclosure and of the frame arrangement according to the disclosure are to be viewed as features, advantages, and advantageous refinements of the battery according to the disclosure, and vice versa. The battery cell pack comprises a large number of battery cells arranged beside one another or above one another and is clamped in the clamping region of the frame arrangement. As a result of swelling of at least one of the battery cells to the swollen dimension, the clamping force in the clamping direction is applied to the clamping part, as a result of which, with the defined yielding of the clamping joint mechanism, the clamping part is moved in the clamping direction toward the fastening part.

Further features of the disclosure can be gathered from the claims, the FIGURE and the FIGURE description. The features and feature combinations described above in the description and the features and feature combinations shown below in the FIGURE description and/or on their own in the FIGURE can be used not only in the respectively specified combination, but also in other combinations or on their own without departing from the scope of the disclosure.

### BRIEF DESCRIPTION OF THE DRAWING

FIG. 1 is a schematic view of a battery, in particular a vehicle battery, which has a frame arrangement with a pressure clamping device.

### DETAILED DESCRIPTION OF THE DRAWING

In the following, a pressure clamping device 1, a frame arrangement 2 and a battery 3 are presented in a common description. In the FIGURE, the same and functionally identical elements are provided with the same designations.

The battery 3 has the frame arrangement 2 which comprises a pressure clamping device 1. Furthermore, the battery 3 in the present example has a counter bearing 4, a plurality of battery cells 5 being clamped in between the counter bearing 4 and the pressure clamping device 1. The counter bearing 4 can be, for example, a further pressure clamping device 1. The battery cells 5 are arranged along a longitudinal direction 6 of the battery 3 to form a battery cell pack 7, for example, stacked to form a battery cell stack. The frame arrangement 2 has a tensioning device 8, which has two tensioning elements 9, for example, tie rods. The tensioning elements 9 or tie rods of the tensioning device 8 are spaced apart from one another along a transverse direction 10 of the battery 3. A clamping region 11 of the frame arrangement 2 is thus delimited by the pressure clamping device 1, by the counter bearing 4, and by the tensioning elements 9. The battery cell pack 7 is arranged in this clamping region 11 and braced or clamped in between the pressure clamping device 1 and the counter bearing 4.

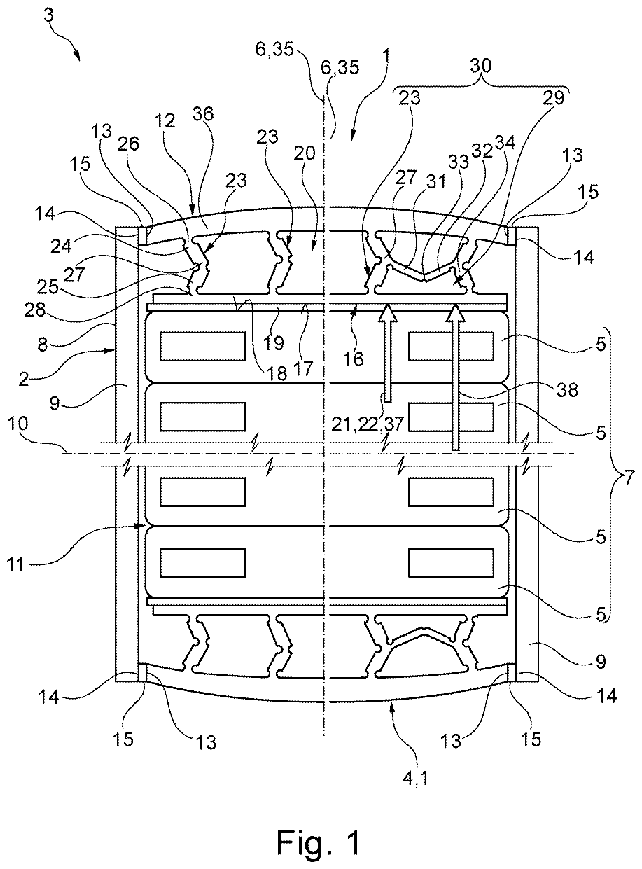

The pressure clamping device 1 and the counter bearing 4 are fastened to each other by way of the tensioning elements 9. To this end, the pressure clamping device 1 has a fastening part 12, via which the pressure clamping device 1 is fastened to the tensioning device 8, in the present case to the tensioning elements 9, as intended-directly in the present example. To this end, the fastening part 12 has a fastening element 13 which, in the present example, is formed as a welding surface. Furthermore, the respective tensioning element 9 has a further fastening element 14 corresponding to the fastening element 13 of the pressure clamping device 1, so that the pressure clamping device 1, in particular its fastening part 12, and the tensioning device 8, in particular its tensioning elements 9, are fastened to each other in a force-fitting, form-fitting, and integral manner by way of the fastening elements 13, 14. In the present example, the pressure clamping device 1 and the tensioning device 8 are fixed to each other by the tensioning elements 9 and the fastening part 12 being welded to each other, in particular laser-welded. This is indicated in FIG. 1 by the welding 15.

It is also possible to see in FIG. 1 that the tensioning elements 9 and the (respective) fastening part 12 are arranged immovably relative to one another. Furthermore, it can be seen that the battery 3, in particular the pressure clamping device 1, in the present example has a plurality of fastening elements 13, a plurality of fastening elements 14, and a plurality of weldings 15. It is to be understood that the pressure clamping device 1 and the tensioning device 8—alternatively or additionally to the welding 15 illustrated and described here—can be connected to one another in a force-fitting, form-fitting, and/or integral manner, for example screwed to one another, riveted, soldered, etc.

The pressure clamping device 1 further has a clamping part 16 which, in the present example, has a clamping surface 17 which corresponds to a contact surface 18 of the battery cell pack 7. Because the battery cell pack 7 is clamped into the frame arrangement 2, the clamping part 16 and the battery cell pack 7 lie against one another, indirectly against one another in the present example. This is because a separating layer 19 is provided between the clamping part 16 and the battery cell pack 7 in the present example, so that the battery cell pack 7 and the clamping part 16 lie against one another via the separating layer 19. The contact surface 18 of the battery cell pack 7 is at least partly formed in particular by an outer surface of a “last” battery cell 5.

The pressure clamping device 1 also has a clamping joint mechanism 20, by way of which the fastening part 12 and the clamping part 16 are connected to each other. In the present example, the fastening part 12, the clamping part 16, and the clamping joint mechanism 20 are formed in one piece with one another. The clamping joint mechanism 20 is formed in such a manner that—when a clamping force 21 acting in the direction toward the fastening part 12 is applied to the clamping part 16—the clamping part 16 is moved in a clamping direction 22 toward the fastening part 12, the clamping joint mechanism 20 yielding in a defined manner during the movement. In particular, the clamping joint mechanism 20 yields in the clamping direction 22. As the clamping joint mechanism 20 yields, the clamping part 16 then moves in relation to the fastening part 12 and in relation to the tensioning device 8, in particular to the tensioning elements 9, since the clamping part 16 and the tension device 8 are not connected directly to each other.

In the present case, the clamping joint mechanism 20 comprises a first joint 23 or a plurality of first joint devices 23, as illustrated in the left-hand half of the image of FIG. 1. The respective first joint device 23 has a first band element 24, and a second band element 25, a swivel joint 26 on the fastening-part side, a central swivel joint 27, and a swivel joint 28 on the clamping-part side. The band elements 24, 25 are connected to each other in an articulated manner via the central swivel joint 27. Furthermore, the first band element 24 and the fastening part 12 are connected to each other in an articulated manner by way of the swivel joint 26 on the fastening-part side, whereas the second band element 25 and the clamping part 16 are connected to each other in an articulated manner by way of the swivel joint 28 on the clamping-part side.

According to a further refinement of the pressure clamping device 1, and the frame arrangement 2, and the battery 3, which is illustrated in the right-hand half of the image of FIG. 1, the clamping joint mechanism 20 has the first joint device 23 and a further (second) joint device 29, a joint device pair 30 being formed by the joint devices 23, 29. The clamping joint mechanism 20 in this case in particular has the joint device pair 30, a third band element 31, and a fourth band element 32, and also a coupling swivel joint 33. This further or second joint device 29 and the first joint device 23 are designed to be the same or at least similar. In particular, the joint devices 23, 29 have the same or similar kinematic properties. It can be seen in FIG. 1 (in the right-hand half of the image) that the joint devices 23, 29 can be designed in mirror-image fashion relative to each other.

In the joint device pair 30, the third band element 31 and the central swivel joint 27 of the first joint device 23 are connected to each other in an articulated manner. Furthermore, the fourth band element 32 and a central swivel joint 34 of the second joint device 29 are connected to each other in an articulated manner. The band elements 31, 32 are connected to each other in an articulated manner by way of the coupling swivel joint 33. To this extent, a movement of the first joint device 23 and a movement of the second joint device 29 are coupled kinematically to each other by the two joint devices 23, 29 being coupled to each other kinematically via the band elements 31, 32 and via the coupling swivel joint 33.

In the present case, the swivel joints 26, 27, 28, 34 and/or the coupling swivel joint 33 are formed as a respective film joint. In particular, provision can be made for all the joints used in the clamping joint mechanism 20 to be formed as a respective film joint.

The pressure clamping device 1, the frame arrangement 2, and/or the battery 3 can be designed to be mirror-symmetrical, wherein the corresponding mirror plane 35 is indicated by the dash-dotted longitudinal directional lines 6. It is equally conceivable that the pressure clamping device 1, the frame arrangement 2, and/or the battery 3 are constructed asymmetrically.

In the present example, the fastening part 12 has a deformation component 36, which in particular is formed as a bending component. This deformation component 36 or bending component in the present example is a constituent part of the clamping joint mechanism 20. In other words, the clamping joint mechanism 20 partly includes the fastening part 12, in that the clamping joint mechanism 20 comprises the deformation component 36 of the fastening part 12. Provision is made for the clamping joint mechanism 20 to yield at least partly in a defined manner by the deformation component 36 deforming, which means, for example, the bending component is bent.

The respective joint device 23, 29 or the respective joint device pair 30 exhibits a resistance to an articulated movement of the corresponding joint device 29, 23, 30. Furthermore, the deformation component 36 of the fastening part 12 exhibits a resistance to the deformation of the deformation component 36. For the defined yielding of the clamping joint mechanism 20, it is therefore necessary for the corresponding resistance to be overcome by the clamping force 21. The resistance to the articulated movement of the corresponding joint device 23, 29, 30 and the resistance to the deformation of the deformation component 36 is differently strong or differently large, so that differently high or differently strong clamping forces 21 are necessary to correspondingly overcome the corresponding resistance. In the present case, provision is made that the resistance to the articulated movement of the joint device 23, 29, 30 can be overcome by a first clamping force 37, whereas this first clamping force 37 is not sufficient to overcome the resistance to the deformation of the deformation component 36. This is because in order to overcome the resistance to the deformation of the deformation component 36, a second clamping force 38 is necessary which, for example, is greater than the first clamping force 37. In an alternative configuration, the first clamping force 37 can be greater than the second clamping force 38. In this manner, an order according to which the clamping joint mechanism 20 yields as intended is predefined. Depending on the material, material thickness and/or shape of the corresponding joint devices 23, 29, 30 and/or the deformation component 36, the respective resistance results and consequently, whether the first clamping force 37 is greater than the second clamping force 38 or vice versa.

The respective clamping force 21, 37, 38—in particular during the operation of the pressure clamping device 1 and the frame arrangement 2 and the battery 3—is applied to the clamping part 16 of the pressure clamping device 1, by one or more of the battery cells 5 swelling to a swollen dimension, starting from its basic dimension. This takes place in particular because of electric charging of the corresponding battery cell 5 and/or because of ageing of the corresponding battery cell 5. Ageing-induced swelling is not or only particularly slightly reversible, whereas discharging-induced or charging-induced swelling by way of an electrical discharge of the corresponding battery cell 5 is at least partly reversible.

In the present example, provision is made for the yielding of the clamping joint mechanism 20 to be wholly or partly nondestructively reversibly elastic. In other words, provision is made for the clamping joint mechanism 20 to reset itself as soon as the clamping force 21, 37, 38 becomes lower (again). The yielding of the clamping joint mechanism can have a first yield component which is nondestructively reversibly elastic and a further yield component which is plastic, which means irreversible. Provision is further made for the ageing-induced swelling of the corresponding battery cell 5 to take place in the yield range of the clamping joint mechanism 20 which is plastic. On the other hand, provision is made for the discharging-induced or charging-induced swelling of the corresponding battery cell 5 to take place in the nondestructively reversibly elastic yield range of the clamping joint mechanism 20. In this manner, the pressure clamping device 1, in particular its clamping part 16, follows the cyclic swelling and shrinking of the corresponding battery cell 5, and therefore the cyclic swelling and shrinking of the battery cell pack 7, whereas the pressure clamping device 1, in particular its clamping part 16, follows the ageing-induced, irreversible swelling of the battery cell 5 or of the battery cell pack 7 by way of plastic deformation or plastic yielding of the clamping joint mechanism 20. This ensures in particular that a desired initial pressure which counteracts crystallization in the interior of the battery cells 5 is always exerted on the corresponding battery cells 5, which means on the battery cell pack 7.

Overall, the pressure clamping device 1, the frame arrangement 2 and the battery 3 indicate a possible manner of particularly advantageously using and arranging the battery cells 5 which change their physical extent between the electrically charged state and the electrically discharged state and as a result of ageing.

### LIST OF DESIGNATIONS

1 Pressure clamping device
2 Frame arrangement
3 Battery
4 Counter bearing
5 Battery cell
6 Longitudinal direction
7 Battery cell stack
8 Tensioning device
9 Tensioning element
10 Transverse direction
11 Clamping region
12 Fastening part
13 Fastening element
14 Fastening element
15 Welding
16 Clamping part
17 Clamping surface
18 Contact surface
19 Separating layer
10 Clamping joint mechanism
21 Clamping force
22 Clamping direction
23 First joint device
24 First band element
25 Second band element
26 Swivel joint on the fastening-part side
27 Central swivel joint
28 Swivel joint on the clamping-part side
29 Further joint device
30 Joint device pair
31 Third band element
32 Fourth band element
33 Coupling swivel joint
34 Central swivel joint
35 Mirror plane
36 Deformation component
37 First clamping force
38 Second clamping force

1.-10. (canceled)

11. A pressure clamping device for a frame arrangement which is designed to clamp a battery cell pack, the pressure clamping device comprising:
a fastening part, via which the pressure clamping device can be fastened to a tensioning device of the frame arrangement;
a clamping part, which is designed to come to lie against the battery cell pack;
a clamping joint mechanism, by way of which the fastening part and the clamping part are connected to one another, wherein when a clamping force acting in the direction toward the fastening part is applied to the clamping part, the clamping part is moved in a clamping direction toward the fastening part, by the clamping joint mechanism yielding in a defined manner.

12. The pressure clamping device according to claim 11,
wherein the clamping joint mechanism has a deformation component of the fastening part, wherein the clamping joint mechanism yields in a defined manner by the deformation component deforming, in particular being bent.

13. The pressure clamping device according to claim 11,
wherein the clamping joint mechanism comprises a first joint device having:
a first band element and a second band element;
a swivel joint on the fastening-part side, via which the fastening part and the first band element are connected to each other in an articulated manner;
a central swivel joint, via which the first band element and the second band element are connected to each other in an articulated manner;
a swivel joint on the clamping-part side, via which the second band element and the clamping part are connected to each other in an articulated manner.

14. The pressure clamping device according to claim 13,
the clamping joint mechanism further comprises:
a second joint device;
a third band element and a fourth band element;
a coupling swivel joint, via which the third band element and the fourth band element are connected to each other in an articulated manner;
wherein the third band element and the central swivel joint of the first joint device are connected to each other in an articulated manner; and,
wherein the fourth band element and the central swivel joint of the second joint device are connected to each other in an articulated manner.

15. The pressure clamping device according to claim 13,
wherein the respective swivel joint is formed as a foil joint.

16. The pressure clamping device according to claim 11,
wherein the fastening part, the clamping part, and the clamping joint mechanism are formed in one piece with one another.

17. The pressure clamping device according to claim 13,
wherein a resistance to an articulated movement of the joint device is carried out at a first clamping force, and wherein a resistance to the deformation of the deformation component of the fastening part takes place at a second clamping force,
wherein the first clamping force is greater than the second clamping force, or
wherein the second clamping force is greater than the first clamping force.

18. The pressure clamping device according to claim 11,
wherein the pressure clamping device is designed in such a manner that the yielding of the clamping joint mechanism is at least partly nondestructively reversibly elastic.

19. A frame arrangement for clamping a battery cell pack, wherein the frame arrangement comprises:
a pressure clamping device according to claim 11 and a counter bearing, which are spaced apart from each other along a longitudinal direction of the frame arrangement;
a tensioning device, which has two tensioning elements spaced apart from each other along the transverse direction of the frame arrangement;
wherein the pressure clamping device and the counter bearing are fastened to each other by means of the tensioning elements, so that a clamping region, into which the battery cell pack can be inserted and clamped, is created between the pressure clamping device and the counter bearing.

20. A battery, which has a frame arrangement according to claim 19, and a battery cell pack, which has a plurality of battery cells arranged beside one another and is clamped in the clamping region, wherein, as a result of swelling of one of the battery cells to a swollen dimension, the clamping force in the clamping direction is applied to the clamping part, as a result of which the clamping part is moved in the clamping direction toward the fastening part with defined yielding of the clamping joint mechanism.
